(19) United States
(12) Patent Application Publication
(10) Pub. No.: US 2006/0231798 A1
(43) Pub. Date: Oct. 19, 2006

(54) Bismuth mediated oxidations

(75) Inventors: Anthony G. M. Barrett, London (GB); Yannick Bonvin, London (GB)

Correspondence Address: WILMER CUTLER PICKERING HALE AND DORR LLP, 60 STATE STREET, BOSTON, MA, 02109, US

(73) Assignee: IC Innovations Limited, London (GB)

(21) Appl. No.: 11/326,668

(22) Filed: Jan. 6, 2006

(30) Foreign Application Priority Data
Jan. 7, 2005 (GB) 0500288.6

(51) Int. Cl. C09K 3/00

(52) U.S. Cl. 252/384

(57) ABSTRACT

A process is provided for the catalytic oxidation of a benzylic alkyl moiety using a bismuth complex and a stoichiometric oxygen source. This new oxidation methodology uses environmentally benign salts of bismuth in a process that uses mild conditions which are suitable for the oxidation of polyfunctional benzylic compounds. The bismuth complexes can contain Bi(III) and/or Bi(V) or the Bi(III) and/or Bi(V) can be formed in situ from Bi(O).

The present invention relates to a novel process for the oxidation of a benzylic alkyl moiety using a bismuth complex and a stoichiometric oxygen source.

Oxidation, particularly the oxidation of benzylic alkyl moieties is an important process in the production of industrially and medically important molecules. Methods of oxidation used in the art have involved the use of stoichiometric inorganic reagents such as potassium permanganate, potassium dichromate, Jones reagent, selenium dioxide, chromium (VI) oxide, etc. It will be appreciated that these reagents have a number of disadvantages associated with their use, including high cost, toxicity and the detrimental environmental effects of the reagents and their waste products. Such reagents can be hazardous in use as a result of the exothermic reactions occurring therewith. The use of such reagents require recovery of the reacted reagent from the reaction mixture and the removal and then storage or disposal of toxic waste products. In addition it is necessary to decontaminate reaction vessels and to thoroughly remove any reagent or waste products thereof from the oxidised products. The processes involved in the use of these reagents can therefore be costly and time consuming and make these reagents unattractive for use on an industrial or commercial scale.

In particular, the reagents known in the art are particularly unsuited for the provision of diaryl ketones and aryl alkyl ketones and the oxidation of benzylic methyl groups to provide benzoic acid and ring substituted derivatives of benzoic acid.

Conventional oxidations of benzylic methyl groups are carried out using stoichiometric or excessive amounts of non-catalytic oxidants such as potassium permanganate. Catalytic or non-catalytic oxidations of benzylic alkyl groups generally require the use of high temperatures and are therefore unsuitable for use with polyfunctional compounds, which are often unstable towards vigorous high temperature reaction conditions.

There is therefore a need in the art for new oxidation reagents which will provide effective and efficient oxidation of a substrate with minimal environmental impact. The new oxidation reagents are further required to allow the provision of polyfunctional compounds, which are currently difficult to obtain economically. The present invention provides the development of new oxidation methodologies using environmentally benign salts of bismuth. In particular, the present invention provides a novel method of efficient benzylic methylene oxidations and benzylic methyl oxidations using mild conditions which are suitable for the oxidation of polyfunctional benzylic compounds.

The first aspect of the invention therefore provides a process for the oxidation of a substrate comprising a benzylic alkyl moiety, said process comprising incubating the substrate with a bismuth complex comprising bismuth and a ligand and a stoichiometric source of oxygen.

For the purposes of this invention the form of bismuth is not limited. The bismuth complex preferably comprises Bi (III) and/or Bi (V) as an oxidising species. The Bi (III) or Bi (V) can be provided in the required oxidation state, or said required oxidation state may be generated during or prior to the oxidation (i.e. the required oxidation state is generated “in situ” in the reaction mixture). The bismuth can therefore be particularly provided as Bi(0) or Bi(III).

The inventors have determined that bismuth is an effective catalyst, for the oxidation of benzylic alkyl groups, more specifically benzylic methylene and/or methyl groups. However, bismuth has not previously been used in the art in this manner due to the poor availability of bismuthate salts (bismuth (V)) in the reaction conditions of the oxidation process (i.e. in organic solvents). The present invention provides a bismuth complex which can be used in the oxidation reactions of the invention. In particular, the invention provides a bismuth complex which can be used in sub-stoichiometric quantities.

This bismuth complex can be provided in solution and/or in suspension. In particular the bismuth complex can be provided wholly or partially in solution.

The bismuth complex preferably comprises bismuth and a ligand of general formula (I)
(Y)ₙ-A-(X)ₙ (I)
wherein A is an aromatic or heteraromatic group, X and Y are chelating groups which may be the same or different and n is an integer of from 1 to 6.

In some embodiments, the chelating group X is provided within the aromatic or heteraromatic group A and the chelating group Y is provided extending from the aromatic or heteroaromatic group A for example as a pendent arm, as illustrated in formula (II) below. 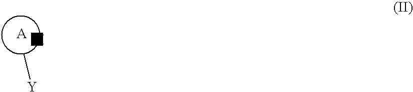
The chelating groups X and Y may comprise any atom which provides one or more pairs of unshared electrons such as a nitrogen or oxygen atom, or a halogen atom, such as chlorine, fluorine, bromine or iodine.

In other embodiments, the ligand can be provided as a compound of formula (III) 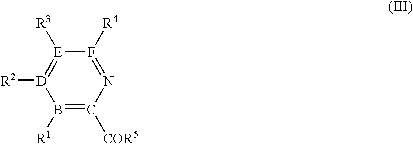
wherein B, D, E, or F are carbon or nitrogen, R¹ is COR⁵ or hydrogen, R², R³ and R⁴ are hydrogen or absent and R⁵ is OR⁶, halide or NR⁷₂ wherein R⁶ and R⁷ are independently hydrogen or C₁₋₆ alkyl. Preferably D is nitrogen, R¹ is COR⁵ and R⁵ is hydrogen or B, D, E and F are carbon and R¹, R², R³ and R⁴ are hydrogen.

It will be appreciated that when any of D, B, E or F are nitrogen, the corresponding group R¹, R², R³ or R⁴ will be absent.

Alternatively, the ligand can be provided as a compound of formula (IV) 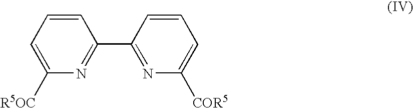
wherein R⁵ is OR⁶ or NR⁷₂ wherein R⁶ and R⁷ are independently hydrogen or C₁₋₆ alkyl.

Alternatively, the ligand can be a compound of formula (V) 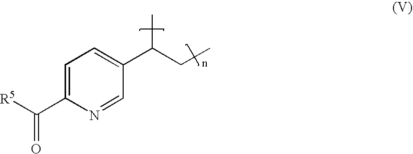
wherein R⁵ is OR⁶ or NR⁷₂ wherein R⁶ and R⁷ are independently hydrogen or C₁₋₆ alkyl and n is an integer of 1 to 6.

Alternatively, the ligand can be a compound of formula (VI) 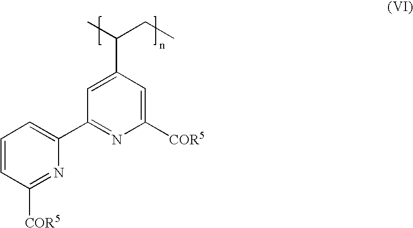
wherein R⁵ is OR⁶ or NR⁷₂ wherein R⁶ and R⁷ are independently hydrogen or C₁₋₆ alkyl and n is an integer of 1 to 6.

In a particular embodiment, the ligand is selected from the following structures:

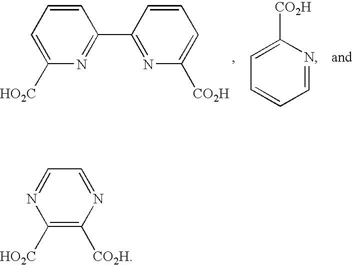

The complex can comprise one or more ligands which can be the same or different, and the complex can comprise 1, 2, 3 or 4 ligands which are the same. In another particular embodiment, the complex comprises one or more ligands from the following: 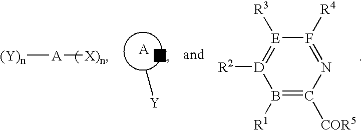
And in a specific embodiment the ligand
(Y)ₙ-A-(X)ₙ
is selected from

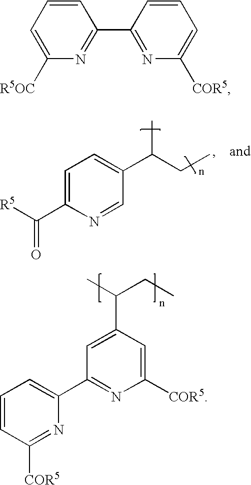

In a particular feature of the first aspect of the invention, the bismuth complex comprises bismuth and picolinic acid. The interaction of bismuth(III) with picolinic acid forms a metallo-organic complex, for example as illustrated below. 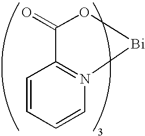
This bismuth-picolinic acid complex provides the bismuth(III) in a chemically available form under the reaction conditions of the present invention, thereby allowing the use of bismuth as an oxidizing reagent in the presence of a stoichiometric oxidant.

The bismuth complex can be preformed (i.e. the complex is formed prior to its use in the oxidation reaction). Alternatively, the complex can be formed in situ (i.e. the bismuth and the ligand are added to the reaction vessel in which the oxidation is taking place, simultaneously, separately or sequentially with the complex being formed in the reaction vessel.

The bismuth catalyst of the first aspect of the invention provides the oxidation of the benzylic methylene moiety via a catalytic pathway. The use of bismuth as a catalyst therefore allows the use of lower levels of the metal thereby providing an environmental and economic advantage over the use of conventional stoichiometric reagents used in the art.

The process of the present invention requires stoichiometric source of oxygen. For the purposes of the present invention, the source of oxygen is preferably a derivative of hydrogen peroxide, and more preferably a peroxide such as hydrogen peroxide, t-butyl hydroperoxide or peracetic acid.

The process of the present invention is preferably carried out in the presence of a hydrogen bond acceptor such as pyridine, pyrazine, 4-methylpyridine or 4-methoxypyridine, and more preferably in the presence of pyridine.

The process of the first aspect of the invention provides for the oxidation of a benzylic alkyl group (i.e. a CH₂ moiety attached to a phenyl group, a substituted phenyl group or a group containing a phenyl group such as naphthyl, or a heteroaryl group). The invention particularly provides a process for the oxidation of a compound of formula (VII)
RˆR′ (VII)
wherein R is an optionally substituted aryl or heterocyclyl and R′ is hydrogen, or an optionally substituted alkyl, aryl or heterocyclic moiety;

or wherein R′ with R forms a five, six or seven membered ring as illustrated in the compound of formula (VIIa) 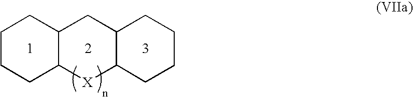
wherein ring 1 is an optionally substituted aryl or heterocyclyl; n is 0, 1 or 2 and X is CH₂ or O; and ring 3 is absent or an optionally substituted aryl or heterocyclic moiety;

or wherein R′ with R forms a compound of formula (VIIb) 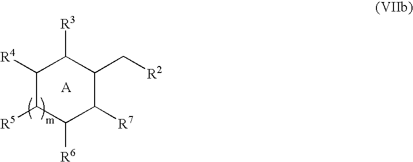
wherein A is an aryl or heterocyclic group, m is 0, 1 or 2, R³, R⁴, R⁵, R⁶ and R⁷ are hydrogen, halogen, cyano, nitro C₁₋₆ alkoxy, C₁₋₆ haloalkyl, C₁₋₆ alkyl, C₃₋₁₂ aryl, C₃₋₁₂ heteroaryl, R⁸SO₂, R⁸₂N or CO₂R⁸ wherein R⁸ is C₁₋₆ alkyl, C₃₋₁₂ aryl or C₃₋₁₂ heteroaryl, or wherein any of R³ and R⁴, R⁴ and R⁵, R⁵ and R⁶ and/or R⁶ and R⁷ together form a five to eight membered cycloalkyl, aryl or heterocyclic group fused to ring A, and wherein R² is hydrogen, or an optionally substituted alkyl, aryl or heterocyclic moiety, or wherein R² is CH₂, O, N or S, R² and R⁸ together form a five to eight membered cycloalkyl, aryl or heterocyclic group.

For the purposes of this invention, the alkyl, aryl or heterocyclic groups may be substituted by one or more of halogen, cyano, nitro C₁₋₆ alkoxy, C₁₋₆ haloalkyl, C₁₋₆ alkyl, C₃₋₁₂ aryl, C₃₋₁₂ heteroaryl, R⁸SO₂, R⁸₂N or CO₂R⁸ wherein R⁸ is C₁₋₆ alkyl, C₃₋₁₂ aryl or C₃₋₁₂ heteroaryl.

It will be appreciated that the process of the first aspect of the invention produces a compound having the formula R—CO₂H when R′ (in VII) is hydrogen and a compound R-CO—R′ when R′ is other than hydrogen. The first aspect therefore provides a process for the production of a compound of formula R—CO₂H comprising oxidation of a compound of formula (V) wherein R′ is H as set out above. Alternatively, the first aspect provides a process for the production of a compound of formula R—CO—R′ comprising oxidation of a compound of formula (V) wherein R′ is an optionally substituted alkyl, aryl or heterocyclic moiety, as set out above.

For the purposes of this invention, alkyl relates to both straight chain and branched alkyl radicals of 1 to 12 carbon atoms, preferably 1 to 8 carbon atoms and most preferably 1 to 4 carbon atoms including but not limited to methyl, ethyl, n-propyl, isopropyl, n-butyl, sec-butyl, isobutyl, tert-butyl, n-pentyl, n-hexyl, n-heptyl, n-octyl. The term alkyl also encompasses cycloalkyl radicals of 3 to 12 carbon atoms, preferably 4 to 8 carbon atoms, and most preferably 5 to 6 carbon atoms including but not limited to cyclopropyl, cyclobutyl, CH₂-cyclopropyl, CH₂-cyclobutyl, cyclopentyl or cyclohexyl. Cycloalkyl groups may be optionally substituted or fused to one or more aryl or heterocyclic group. The alkyl group can be optionally interrupted by one or more heteroatom selected from O or NR′.

“Aryl” means an aromatic 3 to 12 membered hydrocarbon, more preferably a 6-membered hydrocarbon containing one ring or being fused to one or more saturated or unsaturated rings, preferably to one or more partially saturated, unsaturated or fully saturated five to seven membered ring containing zero to three heteroatoms; including but not limited to phenyl, naphthyl, anthracenyl or phenanthracenyl.

“Heterocyclic” means a 3 to 12 membered ring system containing one or more heteroatoms selected from N, O or S and includes heteroaryl. The heterocyclic system can contain one ring or may be fused to one or more saturated or unsaturated rings, preferably to one or more partially saturated, unsaturated or fully saturated five to seven membered ring containing zero to three heteroatoms; the heterocyclic can be fully saturated, partially saturated or unsaturated and includes but is not limited to heteroaryl and heterocarbocyclic. Examples of aryl, cycloalkyl or heterocyclic groups include but are not limited to cyclohexyl, phenyl, benzofuran, benzothiophene, benzoxazole, benzothiazole, dioxin, furan, imidazole, indole, indazole, isoquinoline, oxazole, piperidine, purine, pyrazine, pyrazole, pyridine, pyrrole, quinoline, tetrahydrofuran, tetrazole, thiophene and triazole.

Halogen means F, Cl, Br or I, preferably F or Cl.

The invention particularly relates to the oxidation of one or more compounds selected from diphenylmethane, tetrahydronapthalene, dibenzosuberane, indane, fluorene, 2,3-benzofluorene, xanthene, dihydroanthracene, 1,2,4,5-tetramethylbenzene, 1,3,5-trimethylbenzene, p-methylanisole and 1-methylnapthalene.

The second aspect of the invention provides a compound as produced by a process as defined in the first aspect of the invention.

All features of each of the aspects of the invention apply to all other aspects mutatis mutandis.

The present invention will now be illustrated by reference to one or more of the following non-limiting examples.

### EXAMPLES

### Example 1

### Catalytic Oxidation of Benzylic Positions via Redox Activation of Bismuth

General Oxidation Procedure 1:

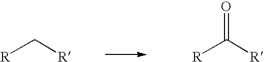

To a suspension of bismuth oxide (37 mg, 10 mol %), in distilled water (1.5 mL), stirred at room temperature in a microwave vessel, was added sodium borohydride (18 mg, 60 mol %). An exothermic reaction was observed, with formation of a finely divided, black precipitate of bismuth metal. Washing with water (2×2 mL), removal of the supernatant afforded activated Bi(0). After addition of pyridine (0.8 mL), acetic acid (0.08 mL), picolinic acid (20 mg, 20 mol %), substrate (0.8 mmol) and t-butyl hydroperoxide (70% in water, 0.66 mL, 6 eq), the vessel was sealed, the mixture sonicated for 30 min, and gradually heated to the indicated temperature, then stirred for the indicated period of time. After completion of the heating period, cooling to room temperature, diluting with diethyl ether, filtration over Celite®, afforded a crude sample, which was analyzed by GCMS.

| | Time | Temp | Conversion |
|---|---|---|---|
| Substrate | (hr) | (° C.) | (GCMS, ketone) |
| Diphenylmethane | 15 | 100 | 99 |
| Tetrahydronaphtalene | 19 | 100 | 85 |
| Dibenzosuberane | 20 | 100 | 95 |
| Indane | 18 | 100 | 70 |
| Fluorene | 19 | 100 | 99 |
| 2,3-benzofluorene | 19 | 100 | 99 |
| Xanthene | 17 | 100 | 99 |
| Dihydroanthracene | 19 | 100 | 95 |
| | | | (diketone) |

General Procedure 2 for the Oxidation of Alkylarenes to Ketones:

NaBH₄ (18 mg, 0.48 mmol) was added with vigorous stirring to a suspension of Bi₂O₃ (37 mg, 0.08 mmol) in distilled H₂O (1.5 mL) at room temperature giving a finely divided, black precipitate of bismuth metal. This was washed with H₂O (2×2 mL), then pyridine (0.8 mL), AcOH (0.08 mL), picolinic acid (20 mg, 0.16 mmol), substrate (0.8 mmol) and t-BuOOH in H₂O (70%; 0.66 mL, 4.8 mmol) were added. The mixture was sonicated for 30 min and heated at 100° C. for 16 h (sealed vessel), cooled, diluted with CH₂Cl₂, filtered through Celite® and rotary evaporated. The resulting oil was analyzed (NMR and GCMS) and chromatographed to yield the corresponding ketone.

It should be noted that the system does not require the use of special precautions and could be carried out in the presence of water and under air. The use of sealed vessels allowed good conversions in these experiments.

Bismuth catalyzed oxidations of cyclic and acyclic alkylarenes.^{a}

| entry | substrate | product | yield (%)^{b} |
|---|---|---|---|
| 1 | 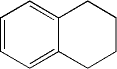 | 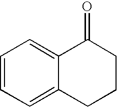 | 77 |
| 2 | 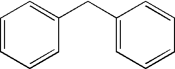 | 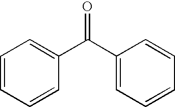 | 95 |
| 3 | 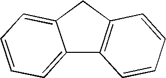 | 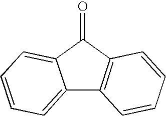 | 91 |
| 4 | 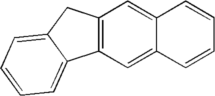 | 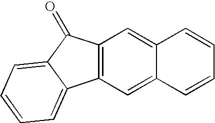 | 99 |
| 5 | 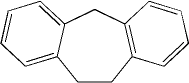 | 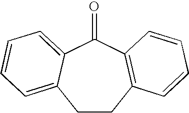 | 70 |
| 6 | 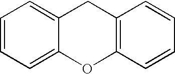 | 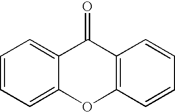 | 88 |
| 7 | 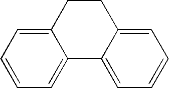 | 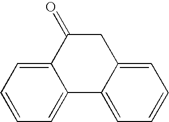 | 50 |
| 8 | 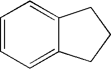 | 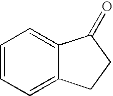 | 65 |
| 9 | 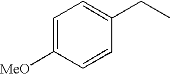 | 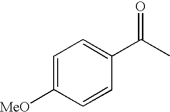 | 93 |
| 10 | 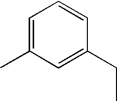 | 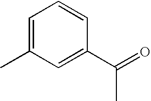 | 54 |
| 11 | 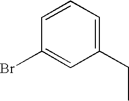 | 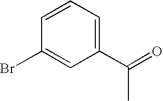 | 71 |
| 12 | 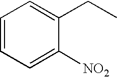 | 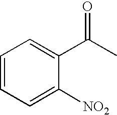 | 68^{c} |
| 13 | 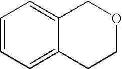 | 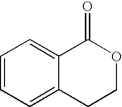 | 91 |
| 14 | 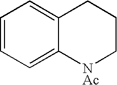 | 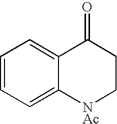 | 56 |
| 15 | 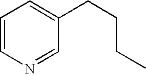 | 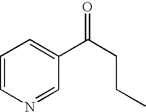 | 48 |
| 16 | 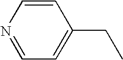 | 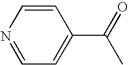 | 74 |
| 17 | 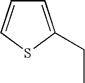 | 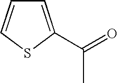 | 72 |
| 18 | 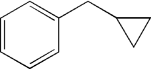 | 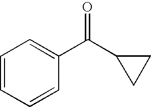 | 72 |

^{b} Yields after chromatography (the samples were all≅95% pure by comparisons of ¹H and ¹³C NMR spectra of samples with commercial materials or, for non-commercial compounds in entries 7, 13, 14 and 15, by comparisons with published data).

^{c} The mixture was allowed to react for 46 h.

Although commercially available bismuth (Aldrich; 100 mesh) could be used, higher yields were obtained with bismuth(0) generated from Bi₂O₃ by reduction using NaBH₄. This is likely to be related to the generation of higher surface area bismuth particles.
On Toluene Derivatives:

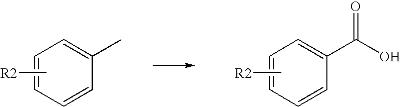

Procedure was identical with Bi₂O₃ (20 mol %), NaBH₄ (1.2 eq), picolinic acid (40 mol %) and t-butyl hydroperoxide (7 eq).

| | Time | Temp | Conversion |
|---|---|---|---|
| Substrate | (hr) | (° C.) | (GCMS, monoacid) |
| 1,2,4,5-tetramethylbenzene | 48 | 110 | 65 |
| 1,3,5-trimethylbenzene | 48 | 110 | 78 |
| p-methylanisole | 19 | 110 | 54 |
| p-methylanisole | 27 | 105 | 95 |
| 1-methylnaphtalene | 21 | 110 | 45 |
| 2,5-dimethoxytoluene | 48 | 110 | 25 |

### Example 2

### Oxidation through Complexes of Bismuth

These are prepared in good yields, through reflux of bismuth oxide with picolinic acid in water, according to the procedure of Zevaco, T.; Guilhaume, N.; Postel, M. New J. Chem. 1991, 15, 927.

Oxidation procedure: To a suspension of the complex (20 mol %) in pyridine, acetic acid (6:1) was added the substrate and t-butyl hydroperoxide (70% in water, 6 eq). The mixture was heated to the indicated temperature for the mentioned period of time. After completion of the heating period, cooling to room temperature, diluting with diethyl ether, filtration over celite, afforded a crude sample, which was analyzed by GC/MS.

Examples of conversion with complex 1:

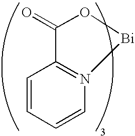

| | | | Conversion |
|---|---|---|---|
| Substrate | Time (hr) | Temp (° C.) | (GCMS, ketone) |
| Tetrahydronaphtalene | 22 | 100 | 75 |
| Dihydroanthracene | 20 | 100 | 80 |
| 1,2,4,5-Tetramethylbenzene | 21 | 100 | 50 |

General Procedure 3 for the Oxidation of Methylarenes o Arenecarboxylic Acids:

A suspension of Bi(OTf)₃ (105 mg, 0.16 mmol), pyridine (0.8 mL), AcOH (0.13 mL), picolinic acid (10 mg, 0.08 mmol), substrate (0.8 mmol) and t-BuOOH in H₂O (70%; 0.77 mL, 5.6 mmol) was sonicated for 30 min and then heated at 110 ° C. for 20 h (sealed vessel). After cooling, EtOAc was added and the resulting suspension was washed with aqueous HCl (10%; 10 mL) and brine (10 mL). The organic layer was dried (MgSO₄), rotary evaporated and the resulting oil was analyzed (NMR and GCMS) and subsequently chromatographed to yield the corresponding carboxylic acid.

| | | | yield |
|---|---|---|---|
| entry | substrate | product | (%)^{a,b} |
| 1 | 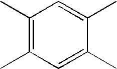 | 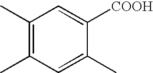 | 72 (59) |
| 2 | 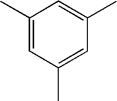 | 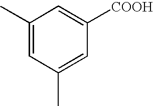 | 74 (65) |
| 3 | 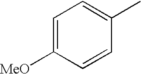 | 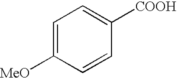 | 87 (72)^{c} |
| 4 | 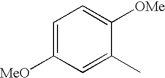 | 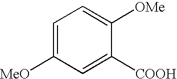 | 61 (49) |
| 5 | 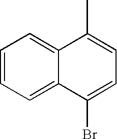 | 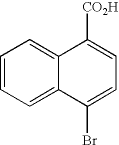 | 58 (56)^{d} |
| 6 | 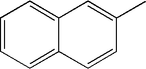 | 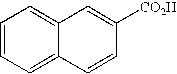 | 54 (50) |
| 7 | 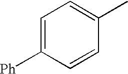 | 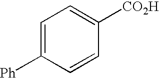 | 67 (60) |
| 8 | 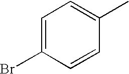 | 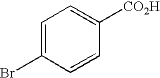 | 67 (63) |

^{a}Approximate yield, based on GC/MS. Yields after chromatography (the samples were all ≧ 95% pure by comparisons of ¹H and ¹³C NMR spectra of samples with commercial materials).
^{b}Reactions carried out following general procedure 3.
^{c}Reaction carried out using Bi(OTf)₃ (5 mol %), picolinic acid (2.5 mol %) and Me₂CO (0.5 mL) as a co-solvent.
^{d}Reaction carried out using Bi(OTf)₃ (10 mol %), picolinic acid (10 mol %) and t-BuOOH in PhH (1.78 M; 7 equiv).

What is claimed is:

1. A process for the oxidation of a substrate comprising a benzylic alkyl moiety, said process comprising incubating the substrate with a bismuth complex comprising bismuth and a ligand, and a stoichiometic source of oxygen.

2. A process as claimed in claim 1, wherein the bismuth complex comprises Bi(III) or Bi(V).

3. A process as claimed in claim 1, wherein the bismuth complex comprises bismuth and a ligand of general formula (I)
(Y)ₙ-A-(X)ₙ (I)
wherein A is an aromatic or heteroaromatic group, X and Y are chelating groups which may be the same or different and n is an integer of from 1 to 6.

4. A process as claimed in claim 1, wherein the ligand is a compound of formula (II) 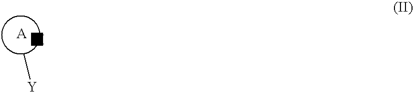
wherein A is an aromatic or heteroaromatic group, X and Y are chelating groups which may be the same or different and n is an integer of from 1 to 6.

5. A process as claimed in claim 3, wherein X and Y comprise any atom which provides one or more pairs of unshared electrons.

6. A process as claimed in claim 3, wherein X and Y are each independently a nitrogen, oxygen, or halogen atom.

7. A process as claimed in claim 1, wherein the ligand is a compound of formula (III) 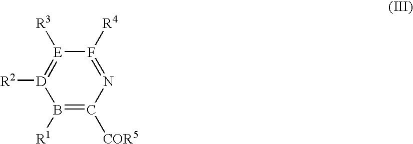
wherein B, D, E, and F are each independently carbon or nitrogen, R¹ is COR⁵ or hydrogen, R², R³ and R⁴ are each independently hydrogen or absent and R⁵ is OR⁶, halide or NR⁷₂, wherein R⁶ and R⁷ are each independently hydrogen or C₁₋₆ alkyl.

8. A process as claimed in claim 3 wherein the ligand is a compound of formula (IV) 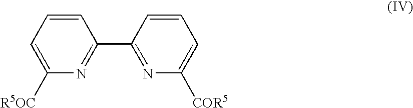
wherein R⁵ is OR⁶ or NR⁷₂ wherein R⁶ and R⁷ are each independently hydrogen or C₁₋₆ alkyl and n is an integer of 1 to 6.

9. A process as claimed in claim 3 wherein the ligand is a compound of formula (V) 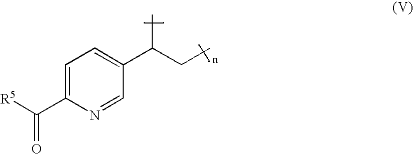
and wherein R⁵ is OR⁶ or NR⁷₂ wherein R⁶ and R⁷ are independently hydrogen or C₁₋₆ alkyl and n is an integer of 1 to 6.

10. A process as claimed in claim 3 wherein the ligand is a compound of formula (VI) 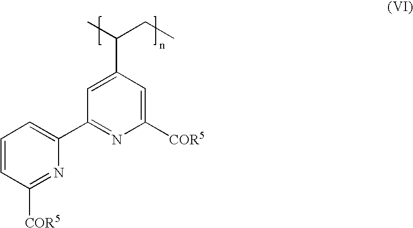
and wherein R⁵ is OR⁶ or NR⁷₂ wherein R⁶ and R⁷ are independently hydrogen or C₁₋₆ alkyl and n is an integer of 1 to 6.

11. A process as claimed in claim 3, wherein the ligand is:

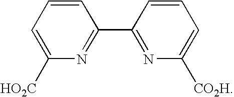

12. A process as claimed in claim 4, wherein the ligand is

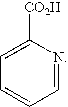

13. A process as claimed in claim 7, wherein the ligand is

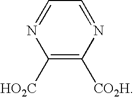

14. A process as claimed in claim 1, wherein the bismuth complex is provided in solution and/or in suspension.

15. A process as claimed in claim 1, wherein the complex comprises one or more ligands selected from the group consisting of:

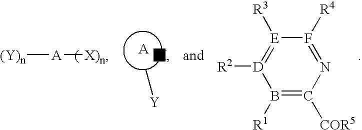

16. A process as claimed in claim 15, wherein the ligand
(Y)ₙ-A-(X)ₙ
is selected from the group consisting of:

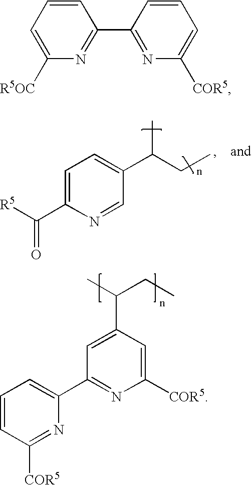

17. A process as claimed in claim 1 wherein the bismuth complex is formed prior to it use in the oxidation reaction or is formed in situ.

18. A process as claimed in claim 1 wherein bismuth complex comprises bismuth and picolinic acid.

19. A process as claimed in claim 1 wherein the oxygen source is a hydrogen peroxide derivative.

20. A process as claimed in claim 1 wherein the bismuth complex is provided in a catalytic amount.

21. A process as claimed in claim 1 wherein the substrate comprises a compound of formula (VII):
RˆR′ (VII)
wherein R is an optionally substituted aryl and R′ is hydrogen, or an optionally substituted alkyl, aryl or hetorcyclic moiety;
or wherein R′ and R form a six membered ring as illustrated in the compound of formula (VIIa): 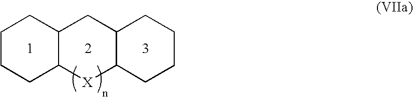
wherein ring 1 is an optionally substituted aryl; n is 0, 1, or 2 and X is CH₂ or O; and ring 3 is absent or an optionally substituted aryl or heterocyclic moiety; and
the alkyl, aryl or heterocyclic groups are substituted by one or more of halogen, cyano, nitro, C₁₋₆ alkoxy, C₁₋₆haloalkyl, C₁₋₆ alkyl, C₃₋₁₂ aryl, C₃₋₁₂ heteroaryl, R⁸SO₂, R⁸₂N or CO₂R⁸ wherein R⁸ is C₁₋₆ alkyl, C₃₋₁₂ aryl, or C₃₋₁₂ heteroaryl.

22. A process as claimed in claim 1 wherein the substrate comprises a compound of formula (VIIb): 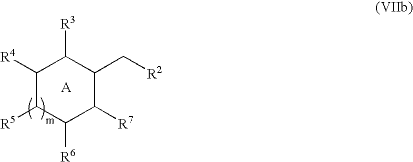
wherein A is an aryl or heterocyclic group,
m is 0, 1, or 2;
R³, R⁴, R⁵, R⁶ and R⁷ are hydrogen, halogen, cyano, nitro C₁₋₆ alkoxy, C₁₋₆haloalkyl, C₁₋₆ alkyl, C₃₋₁₂ aryl, C₃₋₁₂ heteroaryl, R⁸SO₂, R⁸₂N or CO₂R⁸ wherein R⁸ is C₁₋₆ alkyl, C₃₋₁₂ aryl or C₃₋₁₂ heteroaryl, or wherein any of R³ and R⁴, R⁴ and R⁵, R⁵ and R⁶ and/or R⁶ and R⁷ together form a five to eight membered cycloalkyl, aryl or heterocyclic group fused to ring A, and wherein R² is hydrogen, or an optionally substituted alky, aryl or heterocyclic moiety, or wherein R² is CH₂, O, N, or S, and R² and R⁸ taken together form a five to eight membered cycloalkyl, aryl or heterocyclic group.

23. A process as claimed in claim 1 wherein the substrate is one or more compounds selected from diphenylmethane, tetrahydronapthalene, dibenzosuberane, indane, fluorene, 2,3-benzofluorene, xanthene, dihydroanthracene, 1,2,4,5-tetramethylbenzene, 1,3,5-trimethylbenzene, p-methlanisole, and 1-methylnapthalene.

24. A compound produced by a process for the oxidation of a substrate comprising a benzylic alkyl moiety, said process comprising incubating the substrate with a bismuth complex comprising bismuth and a ligand, and a stoichiometic source of oxygen.
